(19) United States
(12) Patent Application Publication
(10) Pub. No.: US 2026/0167180 A1
(43) Pub. Date: Jun. 18, 2026

(54) CONTROL DECISION-MAKING METHOD FOR PRECEDING VEHICLE CUT-IN SCENARIO BASED ON VEHICLE-ROAD PERCEPTION FUSION TECHNOLOGY

(71) Applicant: BEIJING NATIONAL NEW ENERGY VEHICLE TECHNOLOGY INNOVATION CENTER CO. , LTD., Beijing (CN)

(72) Inventors: Xin ZHOU, Beijing (CN); Dinghai PAN, Beijing (CN); Chengyin YUAN, Beijing (CN)

(21) Appl. No.: 18/707,977

(22) PCT Filed: Aug. 11, 2022
(86) PCT No.: PCT/CN2022/111846

§ 371 Date: May 7, 2024

(30) Foreign Application Priority Data
Dec. 23, 2021 (CN) 202111594505.1

(51) Int. Cl. B60W 30/09; B60W 30/18; B60W 50/00; B60W 50/14

(52) U.S. Cl. CPC B60W 30/09; B60W 30/18; B60W 50/0098; B60W 50/14; B60W 2552/10; B60W 2554/4041; B60W 2554/4042; B60W 2554/4045; B60W 2554/802; B60W 2554/804; B60W 2556/35; B60W 2710/18; B60W 2720/106

(57) ABSTRACT

A control decision-making method for a preceding vehicle cut-in scenario based on vehicle-road perception fusion technology, includes: obtaining first-type target information about the preceding vehicle based on a vehicle-mounted perception device of the ego vehicle; obtaining second-type target information about the preceding vehicle based on a vehicle-mounted OBU device of the ego vehicle; predicting whether the preceding vehicle is about to cut into the lane of the ego vehicle based on the first-type target information and the second-type target information; in response to a prediction result that the preceding vehicle is about to cut into the lane of the ego vehicle, determining an assisted driving control mode of the ego vehicle according to a predetermined assisted driving control decision strategy, where the assisted driving control mode is triggering AEB braking, triggering mild decelerating braking, or issuing a cut-in warning of the preceding vehicle to a driver. According to the present invention, the problem that existing vehicle active safety technology cannot effectively avoid collision accidents caused by the cut-in of preceding vehicles can be effectively solved.

### FIELD OF TECHNOLOGY

The present invention relates to the field of intelligent driving technology, and more specifically, relates to a control decision-making method for a preceding vehicle cut-in scenario based on vehicle-road perception fusion technology.

### BACKGROUND

Safe driving is the first rigid demand of automobile users. In the process of driving, vehicle collision is the main factor causing traffic accidents. For example, on highways or other high-speed driving scenarios, a large proportion of traffic accidents are caused by rear-end collisions due to a preceding vehicle cut-in, especially when the preceding vehicle cut-in occurs at a close distance or suddenly and the driver of the vehicle being cut in the original lane is not concentrating. When driving at high speeds, such accidents often cause multi-vehicle chain collisions, with serious casualties and losses.

Although existing technologies attempt to solve the problem of rear-end collision under the preceding vehicle cut-in scenario in the above-mentioned, such as Forward Collision Warning (FCW) and Autonomous Emergency Braking (AEB), they are limited by physical factors, as the reaction delay of such vehicle active safety systems is large, which cannot completely and effectively avoid the occurrence of collision accidents caused by the preceding vehicle cut-in. For example, as shown in FIG. 1, a typical preceding vehicle cut-in scenario is that the ego vehicle (SV) is driving in its lane, and the preceding vehicle (TV) in the adjacent lane intends to cut into the lane of the ego vehicle. If the cut-in behavior occurs suddenly or at a close distance, the ego vehicle cannot make a timely and accurate prediction, and the driver does not have time to react. Even if the ego vehicle is equipped with an ADAS system with AEB function, it may not be able to avoid a collision with the cut-in preceding vehicle.

### SUMMARY

The purpose of the present invention is to solve the problem that the existing vehicle active safety technology cannot effectively avoid the occurrence of collision accidents caused by the preceding vehicle cut-in.

In order to achieve the above purpose, the present invention provides a control decision-making method for a preceding vehicle cut-in scenario based on vehicle-road perception fusion technology, the method is applied to a scenario where an ego vehicle and a preceding vehicle are driving in the same direction in two adjacent lanes, and includes the following steps:
obtaining first-type target information about the preceding vehicle based on the vehicle-mounted perception device of the ego vehicle;
obtaining second-type target information about the preceding vehicle based on the vehicle-mounted OBU device of the ego vehicle;
predicting whether the preceding vehicle is about to cut into a lane where the ego vehicle is located based on the first-type target information and the second-type target information;
in response to a prediction result that the preceding vehicle is about to cut into the lane where the ego vehicle is located, determining assisted-driving control mode of the ego vehicle according to a predetermined assisted-driving control decision strategy, wherein the assisted-driving control mode is triggering AEB braking, triggering mild decelerating braking or issuing a cut-in warning of the preceding vehicle to a driver.

Preferably, the first-type target information includes a preceding vehicle identification signal and position information, driving speed, deceleration and distance to the ego vehicle of the preceding vehicle;
the second-type target information includes vehicle body CAN data, position information, steering wheel angle, driving speed and braking status of the preceding vehicle.

Preferably, predicting whether the preceding vehicle is about to cut into the lane where the ego vehicle is located based on the first-type target information and second-type target information includes:
obtaining fusion perception information about the preceding vehicle based on the first-type target information and second-type target information, where the fusion perception information includes a minimum distance from a side of the preceding vehicle close to the ego vehicle to a middle lane line, driving speed of the preceding vehicle, lateral speed of the preceding vehicle, steering wheel angle of the preceding vehicle and turn signal switch status of the preceding vehicle, wherein if the preceding vehicle is completely outside the lane where the ego vehicle is located, the minimum distance is positive, otherwise, the minimum distance is negative;
judging whether a predetermined first condition is met, where the first condition is that the steering wheel angle of the preceding vehicle is less than a predetermined steering wheel angle threshold and the turn signal of the preceding vehicle is off;
in response to a judgment result that the first condition is met, monitoring the minimum distance from a predetermined initial moment, and if the minimum distance changes toward a negative direction and an absolute value reaches a predetermined first cut-in distance threshold, obtaining a cut-in time of the preceding vehicle based on the minimum distance at the initial moment, the first cut-in distance threshold and the lateral speed of the preceding vehicle, and if the cut-in time of the preceding vehicle is less than a predetermined first cut-in time threshold, determining that the preceding vehicle has a cut-in behavior.

Preferably, predicting whether the preceding vehicle is about to cut into the lane where the ego vehicle is located based on the first-type target information and the second-type target information further includes:
in response to a judgment result that the first condition is not met, monitoring the minimum distance from a predetermined initial moment, and if the minimum distance changes toward a negative direction and an absolute value reaches a predetermined second cut-in distance threshold, obtaining a cut-in time of the preceding vehicle based on the minimum distance at the initial moment, the second cut-in distance threshold and the lateral speed of the preceding vehicle, and if the cut-in time of the preceding vehicle is less than a predetermined second cut-in time threshold, determining that the preceding vehicle has a cut-in behavior; wherein the second cut-in distance threshold is smaller than the first cut-in distance threshold, and the second cut-in time threshold is greater than the first cut-in time threshold;
if the lateral speed of the preceding vehicle is not obtained or the lateral speed of the preceding vehicle is not available, then:
in response to a judgment result that the first condition is met, judging whether the absolute value of the minimum distance is not less than the first cut-in distance threshold, and if so, determining that the preceding vehicle has a cut-in behavior;
in response to a judgment result that the first condition is not met, judging whether the absolute value of the minimum distance is not less than the second cut-in distance threshold, and if so, determining that the preceding vehicle has a cut-in behavior.

Preferably, the assisted-driving control decision strategy includes:
judging whether a predetermined second condition is met, where the second condition is that a pre-acquired driving speed of the ego vehicle is greater than the driving speed of the preceding vehicle or the deceleration of the preceding vehicle is greater than a predetermined preceding vehicle deceleration threshold;
in response to a judgment result that the second condition is not met, obtaining a size relationship between a pre-acquired relative distance between the ego vehicle and the preceding vehicle in direction of the lane where the ego vehicle is located and a predetermined safe distance and a mild decelerating braking trigger distance;
if the relative distance between the ego vehicle and the preceding vehicle in the direction of the lane where the ego vehicle is located is less than the safe distance and not less than the mild decelerating braking trigger distance, taking issuing the cut-in warning of the preceding vehicle to the driver as the assisted-driving control mode;
a method for determining the safe distance includes:
determining a braking distance of the preceding vehicle based on the driving speed of the preceding vehicle and a predetermined first preceding vehicle deceleration setting value;
determining a mild decelerating braking trigger distance of the ego vehicle based on a pre-acquired driving speed of the ego vehicle, a reaction delay of the driver of the ego vehicle and a reaction delay of a braking system of the ego vehicle, and a predetermined mild decelerating braking deceleration;
obtaining a difference between the mild decelerating braking trigger distance of the ego vehicle and the braking distance of the preceding vehicle, and taking sum of the difference and a predetermined first distance threshold as the safe distance;
a method for determining the mild decelerating braking trigger distance includes:
taking sum of the difference and a predetermined second distance threshold as the mild decelerating braking trigger distance, where the second distance threshold is smaller than the first distance threshold.

Preferably, the assisted-driving control decision strategy further includes:
if the relative distance between the ego vehicle and the preceding vehicle in the direction of the lane where the ego vehicle is located is less than the mild decelerating braking trigger distance, taking triggering mild decelerating braking as the assisted-driving control mode.

Preferably, the assisted-driving control decision strategy further includes:
in response to a judgment result that the second condition is met, determining a collision time of the two vehicles when the ego vehicle does not decelerate based on the driving speed of the ego vehicle, the driving speed of the preceding vehicle, the deceleration of the preceding vehicle and the pre-acquired relative distance between the ego vehicle and the preceding vehicle in the direction of the lane where the ego vehicle is located;
if the collision time of the two vehicles when the ego vehicle does not decelerate is less than a predetermined collision time threshold, taking triggering AEB braking as the assisted-driving control mode;
the expression of the collision time threshold is (V_{SV0}−V_{TV0})/a_{SV}+T_{s_d2}, where V_{SV0} is current driving speed of the ego vehicle, V_{TV0} is current driving speed of the preceding vehicle, a_{SV} is a predetermined second preceding vehicle deceleration setting value, and T_{s_d2} is the reaction delay of the braking system of the ego vehicle.

Preferably, the assisted-driving control decision strategy further includes:
in a process of the ego vehicle triggering mild decelerating braking, if it is detected that the relative distance between the ego vehicle and the preceding vehicle in the direction of the lane where the ego vehicle is located is not less than the mild decelerating braking trigger distance, controlling the ego vehicle to exit mild decelerating braking mode.

Preferably, the assisted-driving control decision strategy further includes:
in a process of the ego vehicle triggering AEB braking, if it is detected that the driving speed of the ego vehicle is less than the driving speed of the preceding vehicle, the relative distance of the preceding vehicle in the direction of the lane where the ego vehicle is located is greater than a predetermined AEB braking release distance and the deceleration of the preceding vehicle is less than the mild decelerating braking deceleration, controlling the ego vehicle to gradually exit AEB braking mode.

Preferably, after predicting whether the preceding vehicle is about to cut into the lane where the ego vehicle is located based on the first-type target information and second-type target information, the method further includes:
in response to a prediction result that the preceding vehicle has intention to cut into the lane where the ego vehicle is located but it is insufficient to determine that the preceding vehicle has a cut-in behavior, determining the assisted-driving control mode as issuing a cut-in warning of the preceding vehicle to the driver in advance according to the assisted-driving control decision strategy;
under a premise that the first condition is not met, the following situations belong to the preceding vehicle having the intention to cut into the lane where the ego vehicle is located but insufficient to determine that the preceding vehicle has a cut-in behavior:
when the obtained lateral speed of the preceding vehicle is available: the minimum distance changes toward the negative direction but the absolute value does not reach the second cut-in distance threshold, or the minimum distance changes toward the negative direction and the absolute value reaches the second cut-in distance threshold but the cut-in time of the preceding vehicle is not less than the second cut-in time threshold;
when the lateral speed of the preceding vehicle is not obtained or the obtained lateral speed of the preceding vehicle is not available: the absolute value of the minimum distance is less than the second cut-in distance threshold.

The beneficial effects of the present invention are:
the control decision-making method for a preceding vehicle cut-in scenario based on vehicle-road perception fusion technology of the present invention first obtains first-type target information about the preceding vehicle based on the vehicle-mounted perception device of the ego vehicle, meanwhile obtains second-type target information about the preceding vehicle based on the vehicle-mounted OBU device of the ego vehicle; secondly, predicts whether the preceding vehicle is about to cut into the lane where the ego vehicle is located based on the obtained first-type target information and second-type target information; when it is predicted that the preceding vehicle is about to cut into the lane where the ego vehicle is located, selects one of triggering AEB braking, triggering mild decelerating braking and issuing a cut-in warning of the preceding vehicle to the driver as the assisted-driving control mode of the ego vehicle according to a predetermined assisted-driving control decision strategy.

The control decision-making method for a preceding vehicle cut-in scenario based on vehicle-road perception fusion technology of the present invention obtains the early perception information about other vehicles driving in the adjacent lane of the driving environment of the ego vehicle through the fusion of vehicle-mounted sensing and vehicle-road collaboration technology, and predicts the driving behavior of the vehicle ahead in adjacent lane and predicts the cut-in behavior of the vehicle ahead based on the obtained early perception information. When it is predicted that the preceding vehicle has a cut-in behavior, the corresponding assisted-driving control mode is determined according to the predetermined assisted-driving control decision strategy, so that the ego vehicle can make judgments and reactions in advance, minimizing the possibility of collision between the ego vehicle and the preceding cut-in vehicle. It can be seen that the control decision-making method for a preceding vehicle cut-in scenario based on vehicle-road perception fusion technology of the present invention can effectively solve the problem of the occurrence of collision accidents caused by the preceding vehicle cut-in, which the existing vehicle active safety technology cannot effectively prevent.

Other features and advantages of the present invention is about to be described in detail in the subsequent specific embodiments.

### BRIEF DESCRIPTION OF THE DRAWINGS

Through the combination of the drawings, a more detailed description of the exemplary embodiments of the present invention is given, wherein the same reference numerals in the exemplary embodiments of the present invention usually represent the same parts.

FIG. 1 shows a schematic diagram of a preceding vehicle cut-in scenario according to the background technology of the present invention;

FIG. 2 shows an implementation flow chart of a control decision-making method for a preceding vehicle cut-in scenario based on vehicle-road perception fusion technology according to an embodiment of the present invention;

FIG. 3 shows a schematic diagram of an application scenario according to an embodiment of the present invention;

FIG. 4 shows a schematic diagram of the minimum distance from the side of the preceding vehicle close to the ego vehicle to the middle lane line changing from a positive value to a negative value according to an embodiment of the present invention.

### DESCRIPTION OF THE EMBODIMENTS

Hereinafter, preferred embodiments of the present invention will be described in more detail. Although the following describes the preferred embodiments of the present invention, it should be understood that the present invention can be implemented in various forms and should not be limited to the embodiments described herein. On the contrary, these embodiments are provided to make the present invention more thorough and complete, and to fully convey the scope of the present invention to those skilled in the art.

Embodiment: In the field of intelligent connected vehicles, the integration of vehicles, roads and smart city networks is the current cross-industry development trend, and the development and maturity of “intelligent”+“connected”+“big data” cloud platform technology is the technical basis and guarantee for realizing “intelligent vehicles+”.

Intelligent driving technology is one of the core technical fields of intelligent connected vehicles. Among them, environment perception and control decision-making are the core technical bottlenecks of intelligent driving systems. At present, the system environment perception capability in the field of intelligent driving technology is far from mature, which is the bottleneck of bottlenecks and the key constraint to realize intelligent driving. Single-vehicle perception (vehicle-mounted sensors) and vehicle-road collaboration (V2X) each have their limitations. Only the combination of the two can achieve a breakthrough and leap in intelligent perception technology, which is currently the most feasible system solution, technical route and direction for intelligent driving. In other words, to realize the environment perception capability that enables intelligent driving of automobiles, it is necessary to fuse vehicle-mounted sensors and vehicle-road collaborative information technology, thereby greatly enhancing the perception capability of automobiles, and ultimately achieving a substantial enhancement of the functions, performance and reliability of intelligent driving of automobiles. At the same time, after the popularization of vehicle-road collaborative applications, the cost of single-vehicle intelligent perception can be greatly reduced.

Developing intelligent t connected vehicles based on vehicle-road collaboration and realizing intelligent driving technology is a long road and process to solve the problem of extremely complex and changeable scenarios. Although realizing fully automatic driving is the development direction of intelligent connected vehicle technology, this is a long-term goal, and it will take a long way to achieve universal commercial application. Market demand is the decisive factor to promote technological progress and landing. The industry has recently begun to form a consensus that through V2X technology, solving problems such as driving safety in key dangerous scenarios, traffic congestion, and improving traffic efficiency is the most important primary market need, and also the biggest pain point of safe driving in transportation, which needs to be gradually solved in the next few decades. In other words, solving the driving safety problem in key dangerous scenarios is the most critical goal at present, and promotes the industrialization and landing of technology.

ADAS is a typical driver assistance system for solving driving safety, and it is also the technical foundation for realizing automatic driving. It has been developing rapidly recently and the market is huge. However, although ADAS system products have been applied in the market for many years, its technology is far from mature, and the functions and performance of ADAS are also severely restricted by the perception capabilities of the system. Especially in some special dangerous scenarios, ADAS cannot achieve effective collision avoidance functions. Through V2X technology, the vehicle-mounted system and roadside perception information achieve fusion perception, which can break through the technical bottleneck of the system in perception and decision-making algorithms in some high-risk scenarios, and develop an ADAS+ system with expanded functions and enhanced performance. The purpose of this technical invention is to solve one of the high-risk scenarios that traditional ADAS system technology cannot solve, that is, the driving assistance control decision-making technology of the advanced driving assistance system (ADAS+) based on V2X perception fusion technology in the sudden cut-in scenario of the preceding vehicle.

V2X includes:
V2V: Vehicle to Vehicle (V2V);
V2I: Vehicle to Infrastructure (V2I);
V2P: Vehicle to Pedestrian (V2P);
V2N: Vehicle to Network (V2N).

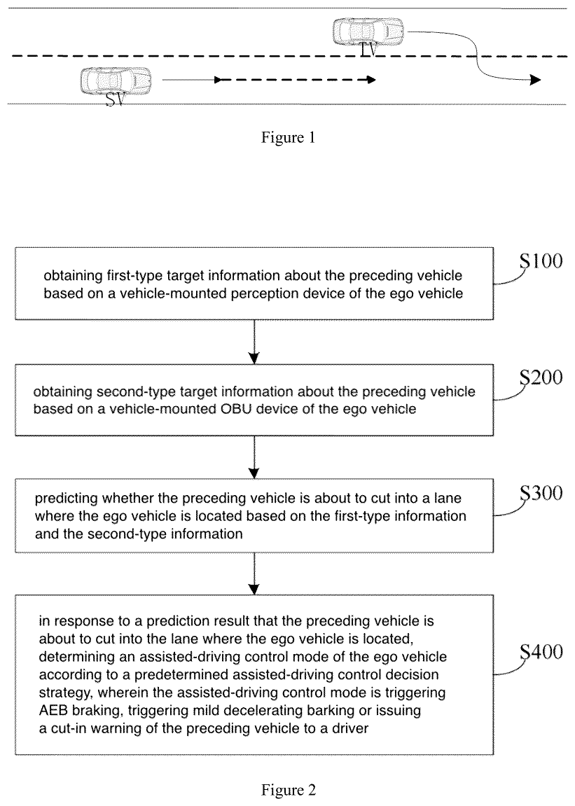

FIG. 2 shows the implementation flow chart of the control decision-making method for a preceding vehicle cut-in scenario based on vehicle-road perception fusion technology according to the embodiment of the present invention. Referring to FIG. 2, the control decision-making method for the preceding vehicle cut-in scenario based on vehicle-road perception fusion technology according to the embodiment of the present invention includes the following steps:
Step S100, obtaining first-type target information about the preceding vehicle based on the vehicle-mounted perception device of the ego vehicle;
step S200, obtaining second-type target information about the preceding vehicle based on the vehicle-mounted OBU device of the ego vehicle;
step S300, predicting whether the preceding vehicle is about to cut into a lane where the ego vehicle is located based on the first-type target information and the second-type target information;
step S400, in response to a prediction result that the preceding vehicle is about to cut into the lane where the ego vehicle is located, determining the assisted-driving control mode of the ego vehicle according to a predetermined assisted-driving control decision strategy, where the assisted-driving control mode is triggering AEB braking, triggering mild deceleration braking or issuing a cut-in warning of the preceding vehicle to a driver.

Further, in step S100 of the embodiment of the present invention, the first-type target information includes a preceding vehicle identification signal and position information, driving speed, deceleration and distance to the ego vehicle of the preceding vehicle.

Further, in step S200 of the embodiment of the present invention, the second-type target information includes vehicle body CAN data, position information, steering wheel angle, driving speed and braking status of the preceding vehicle.

Further, in the embodiment of the present invention, predicting whether the preceding vehicle is about to cut into the lane where the ego vehicle is located based on the first-type target information and the second-type target information in step S300 includes:
Obtaining fusion perception information about the preceding vehicle based on first-type target information and the second-type target information, where the fusion perception information includes a minimum distance from a side of the preceding vehicle close to the ego vehicle to a middle lane line, driving speed of the preceding vehicle, lateral speed of the preceding vehicle, steering wheel angle of the preceding vehicle and turn signal switch status of the preceding vehicle, wherein if the preceding vehicle is completely outside the lane where the ego vehicle is located, the minimum distance is positive, otherwise, the minimum distance is negative;
judging whether a predetermined first condition is met, where the first condition is that the steering wheel angle of the preceding vehicle is less than a predetermined steering wheel angle threshold and the turn signal of the preceding vehicle is off;
in response to a judgment result that the first condition is met, monitoring the minimum distance from a predetermined initial moment, and if the minimum distance changes toward the negative direction and the absolute value reaches a predetermined first cut-in distance threshold, obtaining a cut-in time of the preceding vehicle based on the minimum distance at the initial moment, the first cut-in distance threshold and the lateral speed of the preceding vehicle, and if the cut-in time of the preceding vehicle is less than a predetermined first cut-in time threshold, determining that the preceding vehicle has a cut-in behavior.

Further, in the embodiment of the present invention, predicting whether the preceding vehicle is about to cut into the lane where the ego vehicle is located based on the first-type target information and second-type target information in step S300 further includes:
In response to a judgment result that the first condition is not met, monitoring the minimum distance from a predetermined initial moment, and if the minimum distance changes toward the negative direction and the absolute value reaches a predetermined second cut-in distance threshold, obtaining a cut-in time of the preceding vehicle based on the minimum distance at the initial moment, the second cut-in distance threshold and the lateral speed of the preceding vehicle, and if the cut-in time of the preceding vehicle is less than a predetermined second cut-in time threshold, determining that the preceding vehicle has a cut-in behavior; wherein the second cut-in distance threshold is smaller than the first cut-in distance threshold, and the second cut-in time threshold is greater than the first cut-in time threshold;
if the lateral speed of the preceding vehicle is not obtained or the lateral speed of the preceding vehicle is not available, then:
in response to a judgment result that the first condition is met, judging whether the absolute value of the minimum distance is not less than the first cut-in distance threshold, and if so, determining that the preceding vehicle has a cut-in behavior;
in response to a judgment result that the first condition is not met, judging whether the absolute value of the minimum distance is not less than the second cut-in distance threshold, and if so, determining that the preceding vehicle has a cut-in behavior.

Specifically, if the first condition is not met, that is, the steering wheel angle of the preceding vehicle is not less than the predetermined steering wheel angle threshold or the turn signal of the preceding vehicle is on, it is determined that the preceding vehicle has a clear intention to cut into the lane where the ego vehicle is located. In this case, compared with the situation where the first condition is met, it is necessary to optimize the first cut-in distance threshold and the first cut-in time threshold, replace the first cut-in distance threshold with the second cut-in distance threshold, and replace the first cut-in time threshold with the second cut-in time threshold, that is, substantially reduce the first cut-in distance threshold and increase the first cut-in time threshold. This is set because in the case where the preceding vehicle has a clear intention to cut into the lane where the ego vehicle is located, the corresponding parameter thresholds should be more “strict”.

Further, in the embodiment of the present invention, the assisted-driving control decision strategy includes:
Judging whether a predetermined second condition is met, where the second condition is that the pre-acquired driving speed of the ego vehicle is greater than the driving speed of the preceding vehicle or the deceleration of the preceding vehicle is greater than a predetermined preceding vehicle deceleration threshold;
in response to a judgment result that the second condition is not met, obtaining the size relationship between the pre-acquired relative distance between the ego vehicle and the preceding vehicle in the direction of the lane where the ego vehicle is located and a predetermined safe distance and a mild decelerating braking trigger distance;
if the relative distance between the ego vehicle and the preceding vehicle in the direction of the lane where the ego vehicle is located is less than the safe distance and not less than the mild decelerating braking trigger distance, taking issuing the cut-in warning of the preceding vehicle to the driver as the assisted-driving control mode;
the method for determining the safe distance includes:
determining a braking distance of the preceding vehicle based on the driving speed of the preceding vehicle and a predetermined first preceding vehicle deceleration setting value;
determining a mild decelerating braking trigger distance of the ego vehicle based on the pre-acquired driving speed of the ego vehicle, the reaction delay of the driver of the ego vehicle and the reaction delay of the braking system of the ego vehicle, and a predetermined mild decelerating braking deceleration;
obtaining the difference between the mild decelerating braking trigger distance of the ego vehicle and the braking distance of the preceding vehicle, and taking the sum of the difference and a predetermined first distance threshold as the safe distance;
the method for determining the mild decelerating braking trigger distance includes:
taking the sum of the difference and a predetermined second distance threshold as the mild decelerating braking trigger distance, where the second distance threshold is smaller than the first distance threshold.

Further, in the embodiment of the present invention, the assisted-driving control decision strategy further includes:
if the relative distance between the ego vehicle and the preceding vehicle in the direction of the lane where the ego vehicle is located is less than the mild decelerating braking trigger distance, taking triggering mild decelerating braking as the assisted-driving control mode.

Further, in the embodiment of the present invention, the assisted-driving control decision strategy further includes:
in response to a judgment result that the second condition is met, determining the collision time of the two vehicles when the ego vehicle does not decelerate based on the driving speed of the ego vehicle, the driving speed of the preceding vehicle, the deceleration of the preceding vehicle and the pre-acquired relative distance between the ego vehicle and the preceding vehicle in the direction of the lane where the ego vehicle is located;
if the collision time of the two vehicles when the ego vehicle does not decelerate is less than a predetermined collision time threshold, taking triggering AEB braking as the assisted-driving control mode;
the expression of the collision time threshold is (V_{SV0}−V_{TV0})/a_{SV}+T_{s_d2}, where V_{SV0} is the current driving speed of the ego vehicle, V_{TV0} is the current driving speed of the preceding vehicle, a_{SV} is a predetermined second preceding vehicle deceleration setting value, and T_{s_d2} is the reaction delay of the braking system of the ego vehicle.

Specifically, in the embodiment of the present invention, according to the assisted-driving control decision strategy, when the second condition is met, that is, the driving speed of the ego vehicle is greater than the driving speed of the preceding vehicle or the deceleration of the preceding vehicle is greater than the predetermined preceding vehicle deceleration threshold, the AEB braking trigger judgment link is entered. When the second condition is not met, that is, the driving speed of the ego vehicle is not greater than the driving speed of the preceding vehicle or the deceleration of the preceding vehicle is not greater than the predetermined preceding vehicle deceleration threshold, the size relationship between the relative distance between the ego vehicle and the preceding vehicle in the direction of the lane where the ego vehicle is located and the predetermined safe distance and mild decelerating braking trigger distance is judged. If the relative distance between the ego vehicle and the preceding vehicle in the direction of the lane where the ego vehicle is located is less than the mild decelerating braking trigger distance, triggering mild decelerating braking is taken as the assisted-driving control mode; if the relative distance between the ego vehicle and the preceding vehicle in the direction of the lane where the ego vehicle is located is less than the safe distance and not less than the mild decelerating braking trigger distance, issuing a cut-in warning of the preceding vehicle to the driver is taken as the assisted-driving control mode.

Further, in the embodiment of the present invention, the assisted-driving control decision strategy further includes:
in the process of the ego vehicle triggering mild decelerating braking, if it is detected that the relative distance between the ego vehicle and the preceding vehicle in the direction of the lane where the ego vehicle is located is not less than the mild decelerating braking trigger distance, controlling the ego vehicle to exit the mild decelerating braking mode.

Further, in the embodiment of the present invention, the assisted-driving control decision strategy further includes:
in the process of the ego vehicle triggering AEB braking, if it is detected that the driving speed of the ego vehicle is less than the driving speed of the preceding vehicle, the relative distance of the preceding vehicle in the direction of the lane where the ego vehicle is located is greater than a predetermined AEB braking release distance and the deceleration of the preceding vehicle is less than the mild decelerating braking deceleration, controlling the ego vehicle to gradually exit the AEB braking mode.

Further, in the embodiment of the present invention, after predicting whether the preceding vehicle is about to cut into the lane where the ego vehicle is located based on the first-type target information and the second-type target information in step S300, the method further includes:
in response to a prediction result that the preceding vehicle has the intention to cut into the lane where the ego vehicle is located but it is insufficient to determine that the preceding vehicle has a cut-in behavior, determining the assisted-driving control mode as issuing a cut-in warning of the preceding vehicle to the driver in advance according to the assisted-driving control decision strategy;
under a premise that the first condition is not met, the following situations belong to the preceding vehicle having the intention to cut into the lane where the ego vehicle is located but insufficient to determine that the preceding vehicle has a cut-in behavior:
when the obtained lateral speed of the preceding vehicle is available: the minimum distance changes toward the negative direction but the absolute value does not reach the second cut-in distance threshold, or the minimum distance changes toward the negative direction and the absolute value reaches the second cut-in distance threshold but the cut-in time of the preceding vehicle is not less than the second cut-in time threshold;
when the lateral speed of the preceding vehicle is not obtained or the obtained lateral speed of the preceding vehicle is not available: the absolute value of the minimum distance is less than the second cut-in distance threshold.

The following describes the control decision-making method for the preceding vehicle cut-in scenario based on vehicle-road perception fusion technology according to the embodiment of the present invention in more detail:

### (1) Description of the Application Scenario and the Problem to be Solved

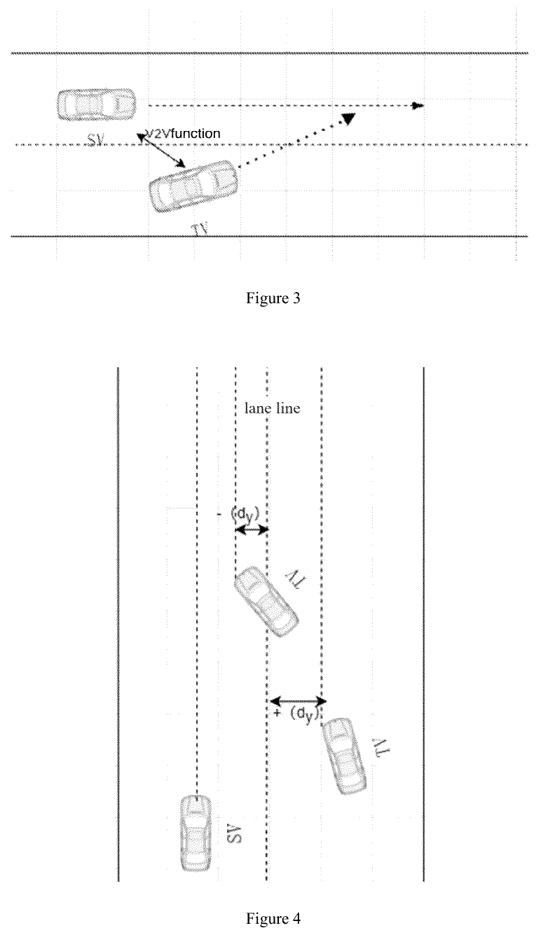

FIG. 3 shows a schematic diagram of an application scenario according to the embodiment of the present invention. Referring to FIG. 3, the road includes at least two lanes, and there are adjacent vehicles driving in the same direction. The ego vehicle SV and the preceding vehicle TV both have V2V function. The ego vehicle SV is driving in its lane, and the preceding vehicle TV is an adjacent vehicle driving in the same direction. When driving, the preceding vehicle TV cuts into the lane where the ego vehicle is located. If the preceding vehicle TV suddenly cuts in and is close to the ego vehicle SV, and the speed of the ego vehicle SV is higher than the speed of the preceding vehicle TV, a rear-end collision is likely to occur, for example, in scenarios of driving on highways or other roads with high speed limits.

The ego vehicle SV is equipped with an ADAS system with Autonomous Emergency Braking (AEB) function, and both the ego vehicle SV and the preceding vehicle TV are equipped with V2V devices (OBU). The ego vehicle SV can obtain some motion and driving operation information of the preceding vehicle TV through the V2V device, perceive or predict the cut-in intention of the preceding vehicle TV in advance, make judgments and control decisions in advance, take necessary control measures in advance, such as early warning, early decelerating or early emergency braking, to achieve the purpose of avoiding rear-end collisions with the preceding vehicle TV.

### (2) Environment Perception and Conditions

The ego vehicle SV is equipped with vehicle-mounted perception devices, such as visual cameras and millimeter-wave radars, for obtaining the preceding vehicle identification signal and the position information, driving speed, deceleration and distance to the ego vehicle SV of the preceding vehicle TV;
the ego vehicle SV is equipped with a vehicle-mounted OBU device for realizing V2V real-time communication and information interaction with the preceding vehicle TV, where the interaction information includes but is not limited to the vehicle body CAN data, position information, steering wheel angle, driving speed and braking status of the preceding vehicle TV;
the preceding vehicle TV is equipped with a vehicle-mounted OBU device for realizing V2V real-time communication and information interaction with the ego vehicle SV, and can transmit its vehicle body CAN data, position information, steering wheel angle, driving speed and braking status to the ego vehicle SV in real time;
the V2V communication between the ego vehicle SV and the preceding vehicle TV can be direct communication between the vehicle-mounted OBU device of the ego vehicle SV and the vehicle-mounted OBU device of the preceding vehicle TV, or it can be indirect communication between the vehicle-mounted OBU device of the ego vehicle SV and the vehicle-mounted OBU device of the preceding vehicle TV based on a roadside RSU device.

### (3) Judgment of Cut-In Behavior

Assumptions about the relative motion relationship between the ego vehicle SV and the preceding vehicle TV:
the ego vehicle SV is driving forward in the lane (straight or curved), and the preceding vehicle TV is driving in the adjacent lane;
the forward driving speed of the ego vehicle is V_{SV0}, and the forward driving speed of the preceding vehicle is V_{TV0};
the minimum distance from the side of the preceding vehicle close to the ego vehicle to the middle lane line is d_{y}, if the preceding vehicle TV is completely outside the lane of the ego vehicle, d_{y} is a positive value, otherwise, d_{y} is a negative value; specifically, the positive and negative values of d_{y} are shown in FIG. 4;
at the T0 moment, the minimum distance from the side of the preceding vehicle close to the ego vehicle to the middle lane line is d_{y0};
the lateral speed of the preceding vehicle TV is V_{y}, if the preceding vehicle TV moves toward the direction of the middle lane line, V_{y} is a negative value, if the preceding vehicle TV moves toward the opposite direction of the middle lane line, V_{y} is a positive value;
the steering wheel angle of the preceding vehicle TV is φ;
the turn signal switch status of the preceding vehicle, the turn signal of the preceding vehicle is on when Tₒₙ=1, and the turn signal of the preceding vehicle is off when Tₒₙ=1.

Calculating from the T0 moment, when the moment is T1, the minimum distance from the side of the preceding vehicle close to the ego vehicle to the middle lane line is:

$${d}_{y} = {d}_{{y}_{0}} + {V}_{y} \times {t}_{cut - in}$$

In the above formula, t_{cut-in} is the cut-in time of the preceding vehicle.

When d_{y} changes toward the negative direction and the absolute value reaches the predetermined first cut-in distance threshold D_{cut-in1} (D_{cut-in1}=1 m), the cut-in time t_{cut-in} of the preceding vehicle is obtained:

$${t}_{cut - in} = ( - {D}_{cut - in 1} - {d}_{{y}_{0}} ) / {V}_{y}$$

When the cut-in time t_{cut-in} of the preceding vehicle is less than the first cut-in time threshold T_{cut-in1}, it is determined that the preceding vehicle TV has a cut-in behavior.

When V_{y} cannot be obtained or the value is unreliable, the formula d_{y}=d_{y0}+V_{y}×t_{cut-in} is no longer used, and it is assumed that d_{y}=d_{y0}, t_{cut-in} is not calculated, and only |d_{y}|≥D_{cut-in1} is used as the basis for determining that the preceding vehicle TV has a cut-in behavior, that is, it is judged whether the absolute value of d_{y} is not less than the first cut-in distance threshold, if so, it is determined that the preceding vehicle TV has a cut-in behavior.

The above-mentioned judgment method of cut-in behavior is applicable to the situation where the ego vehicle SV does not perceive that the steering wheel angle φ of the preceding vehicle TV is greater than the predetermined steering wheel angle threshold or the turn signal of the preceding vehicle is on. When the ego vehicle SV perceives that the steering wheel angle φ of the preceding vehicle TV is greater than the predetermined steering wheel angle threshold or the turn signal of the preceding vehicle is on, the first cut-in distance threshold D_{cut-in1} in the above-mentioned judgment method of cut-in behavior is replaced with the second cut-in distance threshold D_{cut-in2}, and the first cut-in time threshold T_{cut-in1} is replaced with the second cut-in time threshold T_{cut-in2}, where the second cut-in distance threshold D_{cut-in2} is smaller than the first cut-in distance threshold D_{cut-in1}, and the second cut-in time threshold T_{cut-in2} is greater than the first cut-in time threshold T_{cut-in1}.

### (4) Cut-In Warning of the Preceding Vehicle

When it is determined that the preceding vehicle TV has a cut-in behavior and the relative distance between the ego vehicle SV and the preceding vehicle TV is less than a certain safe distance, before triggering AEB braking or mild decelerating braking, the ego vehicle SV first issues a warning to its driver in advance, and the driver can take necessary actions as early as possible to avoid a collision.

Calculation method of the safe distance:
After judging that the preceding vehicle TV cuts into the lane of the ego vehicle, if the preceding vehicle TV performs emergency braking until it stops, the ego vehicle SV can safely stop under the condition of 0.2 g mild deceleration without colliding with the preceding vehicle TV;
the initial vehicle speed of the ego vehicle is V_{SV0}, the deceleration of the ego vehicle is a_{SV0}, the initial vehicle speed of the preceding vehicle is V_{TV0}, and the deceleration of the preceding vehicle is a_{TV0};
the reaction delay of the driver of the ego vehicle is T_{SV_d1}, and the reaction delay of the braking system of the ego vehicle is t_{rbr}=200 ms;
assuming that the preceding vehicle TV performs emergency braking: a_{TVaeb}=0.8 g (the specific deceleration value should be calculated and optimized in real-time according to the current relative vehicle speed and relative distance);
the braking time of the preceding vehicle:

$${t}_{TV 0} = \frac{{V}_{TV 0}}{{a}_{TVaeb}} ;$$

the braking distance of the preceding vehicle:

$${d}_{TVaeb} = \frac{{V}_{TV 0}^{2}}{2 * {a}_{TVaeb}} ;$$

under the condition of mild decelerating braking, the braking time of the ego vehicle:

$${t}_{SV} = \frac{{V}_{SV 0}}{{a}_{SVgen}} ,$$

where a_{SVgen}=0.2 (the specific deceleration value should be calculated and optimized in real-time according to the current relative vehicle speed and relative distance);
under the condition of mild decelerating braking, the braking distance of the ego vehicle:

$${d}_{SVgen} = \frac{{V}_{SV 0}^{2}}{2 * {a}_{SVgen}} + ( {T}_{SV \_ d 1} + {t}_{rbr} ) * {V}_{SV 0} ;$$

when the vehicle stops, the distance between the ego vehicle SV and the preceding vehicle TV dₛₜ=dₛ₀+d_{TVaeb}−d_{SVgen}, (dₛ₀ is the warning distance), dₛₜ>0.

### Warning Condition 1:

To ensure dₛₜ>0, it is necessary to ensure dₛ₀>d_{SVgen}−d_{TVaeb}. In this embodiment of the present invention, a first distance threshold dₚᵣₑ₁ is added, that is, the safe distance is d_{SVgen}−d_{TVaeb}+dₚᵣₑ₁. When the relative distance between the ego vehicle SV and the preceding vehicle TV is less than the safe distance, the system issues a warning. The first distance threshold dₚᵣₑ₁ is a preset value for early warning, and the specific deceleration value should be calculated and optimized in real-time according to the current relative vehicle speed and relative distance.

### Additional Warning Condition 2:

When the preceding vehicle TV has the intention to cut into the lane of the ego vehicle, even if it is still impossible to determine whether the preceding vehicle TV has a cut-in behavior based on the motion trajectory of the preceding vehicle TV, when the relative distance between the ego vehicle SV and the preceding vehicle TV is less than the safe distance, the system of the ego vehicle SV issues a warning to its driver in advance.

The warning trigger condition is: when the steering wheel angle φ of the preceding vehicle TV is greater than the predetermined steering wheel angle threshold or the turn signal of the preceding vehicle is on, the relative distance between the ego vehicle SV and the preceding vehicle TV is less than the safe distance, and the calculation method of the safe distance is the same as above.

### (5) Mild Decelerating Braking:

When it is determined that the preceding vehicle TV has a cut-in behavior, it is judged whether the relative distance between the ego vehicle SV and the preceding vehicle TV is less than the predetermined mild decelerating braking trigger distance. The mild decelerating braking trigger distance is d_{SVgen}−d_{TVaeb}+dₚᵣₑ₂, dₚᵣₑ₂ is the second distance threshold. When d_{S0}<d_{SVgen}−d_{TVaeb}+dₚᵣₑ₂, the mild decelerating braking control is started to maintain the distance between the ego vehicle SV and the preceding vehicle TV. When d_{S0}≥d_{SVgen}−d_{TVaeb}+dₚᵣₑ₂, the mild decelerating braking is exited (applicable to vehicles with automatic driving function, and this function is not set for vehicles driven by drivers).

### (6) Aeb Braking:

Control target principle: When it is determined that the preceding vehicle TV has a cut-in behavior, and the vehicle speed of the ego vehicle V_{SV} is greater than the vehicle speed of the preceding vehicle V_{TV} or the preceding vehicle TV significantly decelerates (|a_{TV}|>0.5 g), the possibility of a potential collision between the ego vehicle SV and the preceding vehicle TV and the deceleration required by the ego vehicle SV to avoid a collision are judged based on the relative distance and relative speed between the ego vehicle SV and the preceding vehicle TV and the deceleration of the preceding vehicle TV. If the ego vehicle SV needs a deceleration a_{SV}>0.5 g to avoid a collision with the preceding vehicle TV, the ego vehicle SV triggers AEB braking (|a_{SV}|>0.5 g) to achieve the purpose of avoiding a collision with the preceding vehicle TV.

### Judgment Conditions for Triggering AEB:

The current vehicle speed of the ego vehicle is V_{SV0}, the deceleration of the ego vehicle is a_{SV}, the current vehicle speed of the preceding vehicle is V_{TV0}, and the deceleration of the preceding vehicle is a_{TV};
the current relative distance between the two vehicles is d_{St0}, the reaction delay of the driver of the ego vehicle: T_{s_d1}, and the reaction delay of the braking system of the ego vehicle: T_{s_d2};
from the T0 moment to the T1 moment:
the state of the ego vehicle SV:
the speed at the T1 moment: V_{SV1}=V_{SV0}+a_{SV}*t (the deceleration takes a negative value);
from the T0 moment to the T1 moment, the driving distance of the ego vehicle SV:

$${d}_{SV 1} = \frac{2 * {V}_{SV 0} + {a}_{SV} * t}{2} * t ;$$

the state of the preceding vehicle TV:
the speed at the T1 moment: V_{TV1}=V_{TV0}+a_{TV}*t (the deceleration takes a negative value);
from the T0 moment to the T1 moment, the driving distance of the preceding vehicle TV:

$${d}_{TV 1} = \frac{2 * {V}_{TV 0} + {a}_{TV} * t}{2} * t ;$$

the relative distance between the ego vehicle SV and the preceding vehicle TV: dₛₜ=dₛ₀+d_{TV1}−d_{SV1};
dₛₜ=0 is the collision point of the ego vehicle SV and the preceding vehicle TV, and the potential collision time is T_{stcoll}. When calculating T_{stcoll}, a_{SV}=0 is used for calculation, and a_{TV} is calculated using the actually measured value, that is, T_{stcoll} is the estimated collision time when the ego vehicle SV does not decelerate.

If T_{stcoll}<(V_{SV0}−V_{TV0})/a_{SV}+T_{s_d2} (where a_{SV} is 0.5 g in the calculation), 0.5-0.8 g emergency braking is started (the deceleration intensity is calculated according to the actual relative speed and distance). When a certain moment V_{SV}−V_{TV0}<0, dₛₜ>20 m, and the deceleration of the preceding vehicle TV a_{TV}<0.2 g, the AEB braking is gradually exited.

The control decision-making method for the preceding vehicle cut-in scenario based on vehicle-road perception fusion technology according to the embodiment of the present invention achieves the fusion of vehicle-mounted perception and roadside perception technology (including between other vehicles) through the application of V2X technology, and solves the problems that cannot be solved by vehicle-mounted perception on the basis of obtaining more reliable and accurate environment perception information. Specifically, it solves the scenario where a vehicle in a nearby lane in front cuts into the driving lane of the ego vehicle. Through the fusion of single-vehicle perception and V2V technology for the perception of the preceding vehicle, the cut-in behavior of the preceding vehicle and the danger of a collision are perceived or predicted as early as possible, thereby increasing the reaction time of the ego vehicle and more effectively realizing the control of the ego vehicle, thus achieving the functions, performance, and reliability that traditional ADAS cannot obtain.

The various embodiments of the present invention have been described above. The above explanations are exemplary and not exhaustive, and are not limited to the disclosed embodiments. Under the condition of not deviating from the scope and spirit of the described embodiments, many modifications and changes are obvious to those skilled in the art.

What is claimed is:

1. A control decision-making method for a preceding vehicle cut-in scenario based on vehicle-road perception fusion technology, applied to a scenario where an ego vehicle and a preceding vehicle are driving in the same direction in two adjacent lanes;
wherein the control decision-making method comprises:
obtaining first-type target information about the preceding vehicle based on a vehicle-mounted perception device of the ego vehicle;
obtaining second-type target information about the preceding vehicle based on a vehicle-mounted OBU device of the ego vehicle;
predicting whether the preceding vehicle is about to cut into a lane where the ego vehicle is located based on the first-type target information and the second-type target information;
in response to a prediction result that the preceding vehicle is about to cut into the lane where the ego vehicle is located, determining an assisted-driving control mode of the ego vehicle according to a predetermined assisted-driving control decision strategy, wherein the assisted-driving control mode is triggering AEB braking, triggering mild decelerating braking or issuing a cut-in warning of the preceding vehicle to a driver.

2. The control decision-making method for a preceding vehicle cut-in scenario based on vehicle-road perception fusion technology according to claim 1, wherein the first-type target information includes a preceding vehicle identification signal and position information, driving speed, deceleration and distance to the ego vehicle of the preceding vehicle;
the second-type target information includes vehicle body CAN data, position information, steering wheel angle, driving speed and braking status of the preceding vehicle.

3. The control decision-making method for a preceding vehicle cut-in scenario based on vehicle-road perception fusion technology according to claim 2, wherein predicting whether the preceding vehicle is about to cut into the lane where the ego vehicle is located based on the first-type target information and the second-type target information includes:
obtaining fusion perception information about the preceding vehicle based on the first-type target information and the second-type target information, wherein the fusion perception information includes a minimum distance from a side of the preceding vehicle close to the ego vehicle to a middle lane line, driving speed of the preceding vehicle, lateral speed of the preceding vehicle, steering wheel angle of the preceding vehicle and turn signal switch status of the preceding vehicle, wherein if the preceding vehicle is completely outside the lane where the ego vehicle is located, the minimum distance is positive, otherwise, the minimum distance is negative;
judging whether a predetermined first condition is met, wherein the first condition is that the steering wheel angle of the preceding vehicle is less than a predetermined steering wheel angle threshold and the turn signal of the preceding vehicle is off;
in response to a judgment result that the first condition is met, monitoring the minimum distance from a predetermined initial moment, and if the minimum distance changes toward a negative direction and an absolute value reaches a predetermined first cut-in distance threshold, obtaining a cut-in time of the preceding vehicle based on the minimum distance at the initial moment, the first cut-in distance threshold and the lateral speed of the preceding vehicle, and if the cut-in time of the preceding vehicle is less than a predetermined first cut-in time threshold, determining that the preceding vehicle has a cut-in behavior.

4. The control decision-making method for a preceding vehicle cut-in scenario based on vehicle-road perception fusion technology according to claim 3, wherein predicting whether the preceding vehicle is about to cut into the lane where the ego vehicle is located based on the first-type target information and the second-type target information further includes:
in response to a judgment result that the first condition is not met, monitoring the minimum distance from a predetermined initial moment, and if the minimum distance changes toward a negative direction and an absolute value reaches a predetermined second cut-in distance threshold, obtaining a cut-in time of the preceding vehicle based on the minimum distance at the initial moment, the second cut-in distance threshold and the lateral speed of the preceding vehicle, and if the cut-in time of the preceding vehicle is less than a predetermined second cut-in time threshold, determining that the preceding vehicle has a cut-in behavior; wherein the second cut-in distance threshold is smaller than the first cut-in distance threshold, and the second cut-in time threshold is greater than the first cut-in time threshold;
if the lateral speed of the preceding vehicle is not obtained or the lateral speed of the preceding vehicle is not available, then:
in response to a judgment result that the first condition is met, judging whether the absolute value of the minimum distance is not less than the first cut-in distance threshold, and if so, determining that the preceding vehicle has a cut-in behavior;
in response to a judgment result that the first condition is not met, judging whether the absolute value of the minimum distance is not less than the second cut-in distance threshold, and if so, determining that the preceding vehicle has a cut-in behavior.

5. The control decision-making method for a preceding vehicle cut-in scenario based on vehicle-road perception fusion technology according to claim 4, wherein the assisted-driving control decision strategy includes:
judging whether a predetermined second condition is met, wherein the second condition is that a pre-acquired driving speed of the ego vehicle is greater than the driving speed of the preceding vehicle or the deceleration of the preceding vehicle is greater than a predetermined preceding vehicle deceleration threshold;
in response to a judgment result that the second condition is not met, obtaining a size relationship between a pre-acquired relative distance between the ego vehicle and the preceding vehicle in direction of the lane where the ego vehicle is located and a predetermined safe distance and a mild decelerating braking trigger distance;
if the relative distance between the ego vehicle and the preceding vehicle in the direction of the lane where the ego vehicle is located is less than the safe distance and not less than the mild decelerating braking trigger distance, taking issuing the cut-in warning of the preceding vehicle to the driver as the assisted-driving control mode;
a method for determining the safe distance includes:
determining a braking distance of the preceding vehicle based on the driving speed of the preceding vehicle and a predetermined first preceding vehicle deceleration setting value;
determining a mild decelerating braking trigger distance of the ego vehicle based on a pre-acquired driving speed of the ego vehicle, a reaction delay of the driver of the ego vehicle and a reaction delay of a braking system of the ego vehicle, and a predetermined mild decelerating braking deceleration;
obtaining a difference between the mild decelerating braking trigger distance of the ego vehicle and the braking distance of the preceding vehicle, and taking sum of the difference and a predetermined first distance threshold as the safe distance;
a method for determining the mild decelerating braking trigger distance includes:
taking sum of the difference and a predetermined second distance threshold as the mild decelerating braking trigger distance, wherein the second distance threshold is smaller than the first distance threshold.

6. The control decision-making method for a preceding vehicle cut-in scenario based on vehicle-road perception fusion technology according to claim 5, wherein the assisted-driving control decision strategy further includes:
if the relative distance between the ego vehicle and the preceding vehicle in the direction of the lane where the ego vehicle is located is less than the mild decelerating braking trigger distance, taking triggering mild decelerating braking as the assisted-driving control mode.

7. The control decision-making method for a preceding vehicle cut-in scenario based on vehicle-road perception fusion technology according to claim 6, wherein the assisted-driving control decision strategy further includes:
in response to a judgment result that the second condition is met, determining collision time of the two vehicles when the ego vehicle does not decelerate based on the driving speed of the ego vehicle, the driving speed of the preceding vehicle, the deceleration of the preceding vehicle and the pre-acquired relative distance between the ego vehicle and the preceding vehicle in the direction of the lane where the ego vehicle is located;
if the collision time of the two vehicles when the ego vehicle does not decelerate is less than a predetermined collision time threshold, taking triggering AEB braking as the assisted-driving control mode;
an expression of the collision time threshold is (V_{SV0}−V_{TV0})/a_{SV}+T_{s_d2}, wherein V_{SV0} is current driving speed of the ego vehicle, V_{TV0} is current driving speed of the preceding vehicle, a_{SV} is a predetermined second preceding vehicle deceleration setting value, and T_{s_d2} is the reaction delay of the braking system of the ego vehicle.

8. The control decision-making method for a preceding vehicle cut-in scenario based on vehicle-road perception fusion technology according to claim 7, wherein the assisted-driving control decision strategy further includes:
in a process of the ego vehicle triggering mild decelerating braking, if it is detected that the relative distance between the ego vehicle and the preceding vehicle in the direction of the lane where the ego vehicle is located is not less than the mild decelerating braking trigger distance, controlling the ego vehicle to exit mild decelerating braking mode.

9. The control decision-making method for a preceding vehicle cut-in scenario based on vehicle-road perception fusion technology according to claim 8, wherein the assisted-driving control decision strategy further includes:
in a process of the ego vehicle triggering AEB braking, if it is detected that the driving speed of the ego vehicle is less than the driving speed of the preceding vehicle, the relative distance of the preceding vehicle in the direction of the lane where the ego vehicle is located is greater than a predetermined AEB braking release distance and the deceleration of the preceding vehicle is less than the mild decelerating braking deceleration, controlling the ego vehicle to gradually exit AEB braking mode.

10. The control decision-making method for a preceding vehicle cut-in scenario based on vehicle-road perception fusion technology according to claim 9, wherein after predicting whether the preceding vehicle is about to cut into the lane where the ego vehicle is located based on the first-type target information and the second-type target information, the method further includes:
in response to a prediction result that the preceding vehicle has intention to cut into the lane where the ego vehicle is located but it is insufficient to determine that the preceding vehicle has a cut-in behavior, determining the assisted-driving control mode as issuing a cut-in warning of the preceding vehicle to the driver in advance according to the assisted-driving control decision strategy;
under a premise that the first condition is not met, the following situations belong to the preceding vehicle having the intention to cut into the lane where the ego vehicle is located but insufficient to determine that the preceding vehicle has a cut-in behavior:
when the obtained lateral speed of the preceding vehicle is available: the minimum distance changes toward the negative direction but the absolute value does not reach the second cut-in distance threshold, or the minimum distance changes toward the negative direction and the absolute value reaches the second cut-in distance threshold but the cut-in time of the preceding vehicle is not less than the second cut-in time threshold;
when the lateral speed of the preceding vehicle is not obtained or the obtained lateral speed of the preceding vehicle is not available: the absolute value of the minimum distance is less than the second cut-in distance threshold.
